(19) United States
(12) Patent Application Publication
(10) Pub. No.: US 2020/0384720 A1
(43) Pub. Date: Dec. 10, 2020

(54) Cores for Composite Material Sandwich Panels

(71) Applicant: Gurit (UK) Ltd., Isle of Wight, Hampshire (GB)

(72) Inventor: Damian James Bannister, Winchester, Hampshire (GB)

(21) Appl. No.: 16/470,275

(22) PCT Filed: Dec. 19, 2017
(86) PCT No.: PCT/EP2017/083487

§ 371 Date: Jun. 17, 2019

(30) Foreign Application Priority Data
Dec. 22, 2016 (GB) 1621950.3

(51) Int. Cl. B32B 3/08; B32B 3/18; B32B 5/18; B32B 5/02; B32B 5/24; B32B 7/12; B32B 17/04; B32B 21/04; B32B 21/10; B29C 44/12

(52) U.S. Cl. CPC B32B 3/085; B29L 2031/085; B32B 5/18; B32B 5/02; B32B 5/245; B32B 7/12; B32B 17/04; B32B 21/047; B32B 21/10; B29C 44/1266; B32B 2250/03; B32B 2250/40; B32B 2255/102; B32B 2255/26; B32B 2260/023; B32B 2260/026; B32B 2260/046; B32B 2262/101; B32B 2266/0278; B32B 2266/08; B32B 2307/54; B32B 2307/542; B32B 2307/722; B32B 2307/732; B32B 2603/00; B32B 2607/00; B32B 2317/16; B32B 2363/00; B32B 2315/085; B32B 3/18

(57) ABSTRACT

Core for a composite material sandwich panel, the core having a rectangular array of aligned elongate elements, composed of balsa wood, in a continuous matrix of a polymeric foam which has been moulded around the elements, wherein the elements each have a polygonal cross-section, the matrix filling voids between adjacent elements and bonding together the elements to form a unitary body and the array of elements extends between the opposite major surfaces in a thickness direction of the core and wherein woodgrain of the elements extends in the thickness direction.

### FIELD OF THE INVENTION

The present invention relates to a core for a composite material sandwich panel comprising outer layers of a fibre reinforced matrix resin composite material. The present invention also relates to a method of manufacturing a core for a composite material sandwich panel, in particular a core of a sandwich panel comprising outer layers of a fibre reinforced matrix resin composite material.

### BACKGROUND

It is well known in the art of structural composite materials to employ a wood such as balsawood (hereinafter also called “balsa”) as the material of a core of a sandwich panel comprising outer layers of a fibre reinforced matrix resin composite material. The sandwich panel is typically manufactured by disposing respective fibre layers on opposite surfaces of the balsa and then infusing a curable resin into the fibre layers and against the opposite surfaces during a vacuum assisted resin transfer moulding step. The resin is then cured to form the sandwich panel.

Balsa has high compression strength and shear strength which can correspondingly provide high compression strength and shear strength to a core of a sandwich panel. However, balsa is a natural material and so has a structure and properties which are not particularly uniform. In particular, balsa varies in density and therefore it is difficult to produce a balsa core having highly uniform and predictable engineering properties.

There is a need to provide a core for a composite material sandwich panel which includes a wood such as balsa and can exhibit more uniform mechanical properties, in particular more uniform density, than is present in a typical sample block of wood such as balsa.

Balsa that is commercially available for the manufacture of structural products has a relatively high density of 130-160 kg/m³, which is heavier than many structural polymeric foams used for engineering applications and in particular as sandwich cores. For example, the Applicant's commercially available CoreCell® styrene acrylonitrile (SAN) structural foam, and current PVC and PET structural foams, may have a density in the range of 60-110 kg/m³, although higher density versions of these foams are also commercially available. Although lower density balsa can be harvested from balsawood trees earlier than the current 5 year minimum age at harvesting, this is not economical as the yield of balsa from the tree is too low.

There is a need to provide a core for a composite material sandwich panel which includes a wood such as balsa and can exhibit high quality mechanical properties such as compression strength and shear strength at a core density lower than known balsa cores.

In order to provide a core having high shear strength, it is known that the balsa tree is cut into strips. Typically the strips are 1-1.5 m in length and of the order of 50×50 mm in cross section, with the length of the strips aligned with the trunk direction of the tree. These strips are bonded together in a press to make a balsa block typically 1-1.5 m tall by 1.2 wide and 0.7 m deep, with the block having a longitudinal direction aligned with the tree trunk direction. The blocks are then cut into sheets, with the major planar cut surfaces of the sheets being substantially transverse to the height direction of the balsa tree. The cut surfaces expose the ends of vessels, typically 0.2 to 0.4 mm in diameter, which are acicular cells which form the major part of the balsa tree water transport system. In a cut sheet for manufacturing a core, the vessel portions extend between the major planar cut surfaces of the sheet. Axial parenchyma cells, typically 0.02 to 0.04 mm in diameter, and fibres also extend between the major planar cut surfaces of the sheet. However, such transverse surfaces, by exposing the ends of the vessels and the ends of the axial parenchyma cells, tend to absorb a large amount of resin which is infused into the fibrous reinforcement material during the vacuum assisted resin transfer moulding step. The absorbed resin in the core adds significant weight to the sandwich panel, without increasing the mechanical properties of the sandwich panel, which is undesirable. Also, the absorption of resin into the balsawood core increases raw material costs during manufacturing.

The opposite surfaces of the balsawood core tend to have a propensity to take-up the curable resin by absorption of the resin into the opposite surfaces, when the resin is infused against the surfaces during a vacuum assisted resin transfer moulding step. Such a cellular structure of the balsa results in the balsa absorbing high volumes, and weights, of resin during processing to form the core of a sandwich panel. Typically, balsa absorbs up to 2.5 kg/m³ of resin during processing to form the core of a sandwich panel.

There is therefore also a need to minimise the resin take-up of a core comprising wood such as balsa, which resin take-up adds undesired weight and cost to the sandwich panel.

Balsa is rigid and cannot be draped to form a three dimensional shape against a three dimensional surface defined by a mould. It is known to slit balsa sheets into blocks and assemble the blocks onto a flexible scrim, for example as disclosed in U.S. Pat. No. 4,568,585, to enable the resultant core to be draped onto three dimensional surface of a mould. However, the assembly provides gaps between the adjacent balsa blocks which result in additional parasitic resin absorption resin during processing to form the core of a sandwich panel.

There is therefore also a need to increase the flexibility of a core comprising wood, such as balsa, which can more readily be three dimensionally shaped.

When a supply of balsa is used to make a balsa core for a composite material sandwich panel, in order to try achieve uniform mechanical properties, in particular uniform density, than is present in a typical balsa tree, some of the balsa from the tree is rejected. In other words, the yield of balsa useful for engineering applications such as sandwich core manufacture is reduced as a result of the variable properties of the balsa from a given tree or harvested batch of trees. It is known from US-A-2003/0049428 to provide a core composed of processed kenaf, balsa or other cellulosic stalks which are bonded together by a resin, which allows the manufacture of “plastic wood” products, but such products would not exhibit uniform mechanical properties, in particular low density, as required by some engineering cores.

In combination, there is a need for sandwich panels incorporating a core comprising wood, such as balsa, to exhibit a combination of high mechanical properties, including a high uniformity, low density and low resin uptake, and which is efficient, easy and inexpensive to manufacture.

It is well known to produce wind turbine blades which use a core for a composite material sandwich panel. Such a wind turbine blade, which typically has a length of greater than 50 meters, has a large surface area to capture the aerodynamic loads and transfer them via a structural beam to the hub of the generator to create rotation. Due to the large surface area of the blade, the blade skins need to have sufficient stiffness to prevent panel budding, and to create this panel stiffness at the lowest possible weight, a sandwich panel construction is used.

Although balsa is known for use as a core material in sandwich panels for wind turbine blades, there is still a need for a core material comprising wood, such as balsa, which, as compared to known high density balsa cores, has a reduced weight per cubic meter of the core. There is also a need to reduce the resin take-up by the wood, e.g. balsa. There is further a need to increase the uniformity of the mechanical properties to provide an engineered core having mechanical properties that are, as compared to known balsa cores, more consistent and predictable in mechanical performance There is also the desire to avoid using a flexible scrim on wood, such as balsa, which creates gaps between the individual wood blocks when the scrim is conformed to a 3D surface, leading to the problem of high resin absorption into the gaps. There is a need to provide a core comprising wood, such as balsa, which can enable conformation of the wood to a 3D surface without encountering high resin absorption into the wood in the core.

The present invention aims at least partially to meet one or more of these needs.

### SUMMARY OF THE INVENTION

Accordingly, the present invention provides a core for a composite material sandwich panel, the core comprising a regular array of a plurality of aligned elongate elements, composed of balsa wood, in a continuous matrix of a polymeric foam which has been moulded around the elements, wherein the elements each have a polygonal cross-section, the matrix filling voids between adjacent elements and bonding together the elements to form a unitary body, wherein the array is a rectangular array having first and second orthogonal directions, in the first orthogonal direction the elements in the array forming a plurality of parallel lines, each parallel line comprising a series of the elements, and the elements in each parallel line being offset, in the first orthogonal direction, relative to the elements in the parallel lines which are adjacent in the second orthogonal direction, wherein the core has respective opposite major surfaces, the array of elements extends between the opposite major surfaces in a thickness direction of the core and wherein woodgrain of the elements extends in the thickness direction.

Preferred features are defined in the dependent claims.

The present invention further provides a method of manufacturing a core for a composite material sandwich panel according to the invention, the method comprising the steps of: (a) providing an array of a plurality of aligned elongate elements, composed of wood, in a mould; and (b) forming a matrix of a polymeric foam around the array within the mould to form a moulded core, the matrix filling voids between adjacent elements and bonding together the elements to form a unitary body

The present invention further provides a composite material sandwich panel comprising a core according to the invention sandwiched between opposed outer layers of fibre reinforced matrix resin material.

The present invention further provides a structural element incorporating the composite material sandwich panel of the invention.

The present invention further provides a wind turbine blade, or a marine component or craft, incorporating a structural element according to the invention.

Although the preferred embodiments of the present invention employ balsa as the wood forming the elements in the core, in addition to balsa the present invention can use any other wood material depending on the density and structural properties, in particular compressive modulus and shear modulus, of the elements and of the resultant core. Furthermore, the elements may optionally be composed of more than one wood, with either each element being formed of an individual wood, and plural elements having different woods, and/or individual elements being formed of plural different woods.

The preferred embodiments of the present invention provide an engineered balsa core which can utilise the high mechanical properties of balsa, in particular high compression modulus and shear modulus, yet has a reduced density for the core as a result of providing an engineered core structure of balsa and a lower density polymeric foam. The weight per square metre of the core can be reduced without significantly compromising the mechanical properties of the core which are required for many applications, in particular for use in the root and/or blade portion of a structural sandwich component in a wind turbine blade. Reducing the proportion of high density balsa in the core in favour of lower density polymeric foam reduces the total density of the core. Also, the foam surfaces tend to take up less resin during processing than the balsa, and so there is a further reduction in weight of the engineered core as a result of reduced resin take up by the core during processing to form the structural sandwich component.

The use of a polymeric foam, which has substantially uniform properties, in particular density, in the engineered core, increases the uniformity of the mechanical properties of the core as compared to a core that comprises only balsa. The resultant engineered core has more consistent and predictable mechanical properties and performance than a core that comprises only balsa.

The cost per cubic metre of a polymeric foam, in particular a polyurethane foam which can be made at a low density of typically about 20 to 80 kg/m³, is lower than the cost per cubic metre of balsa. Consequently, the engineered core can have a lower production cost than a core that comprises only balsa.

The preferred embodiments of the present invention provide an engineered balsa core which can have a lower elastic modulus (E) than that of balsa alone. Consequently, the engineered balsa core is more flexible than a core that comprises only balsa, and there is no necessity to form slits in the core which would increases undesired resin take up by the core. Furthermore, since the polymeric foam can be softened by heating, so as to have lower mechanical properties and so as to be mouldable, the engineered balsa core can be three dimensionally shaped by thermoforming.

The preferred embodiments of the present invention provide an engineered balsa core which can provides a high shear modulus (G) for the entire core, sufficient to provide the required shear properties for use in a wind turbine blade.

The preferred embodiments of the present invention provide an engineered balsa core which can utilise balsa elements having more varying mechanical properties than could be used for a core that comprises only balsa, since the engineered core has anyway more uniform properties than balsa alone as a result of the hybrid structure with the polymeric foam.

The preferred embodiments of the present invention provide an engineered balsa core which has a particular “header bond” cross-section with regard to the array of balsa elements in the continuous matrix of polymeric foam. The “header bond” cross-section has been found to provide structural support for the skin laminate of a sandwich panel incorporating the core which avoids skin wrinkling or skin bucking under an applied load in the plane of the core, which represents an axial load applied to a sandwich panel in a wind turbine blade. The use of progressively smaller cross-section balsa elements tends to reduce the problem of skin wrinkling.

### BRIEF DESCRIPTION OF THE DRAWINGS

Embodiments of the present invention will now be described by way of example only, with reference to the accompanying drawings, in which:

FIG. 1 schematically illustrates an enlarged plan view of a surface of balsa core in accordance with an embodiment of the invention;

FIG. 2 schematically illustrates a side view of the balsa core of FIG. 1 in a composite material sandwich panel;

FIG. 3 schematically illustrates an enlarged plan view of a surface of balsa core in accordance with a second embodiment of the invention;

FIG. 4 schematically illustrates an enlarged plan view of a surface of balsa core in accordance with a third embodiment of the invention; and

FIG. 5 schematically illustrates a sectional side view of a jig and mould for forming the core of FIG. 1 in a core manufacturing method in accordance with an embodiment of the invention.

### DETAILED DESCRIPTION

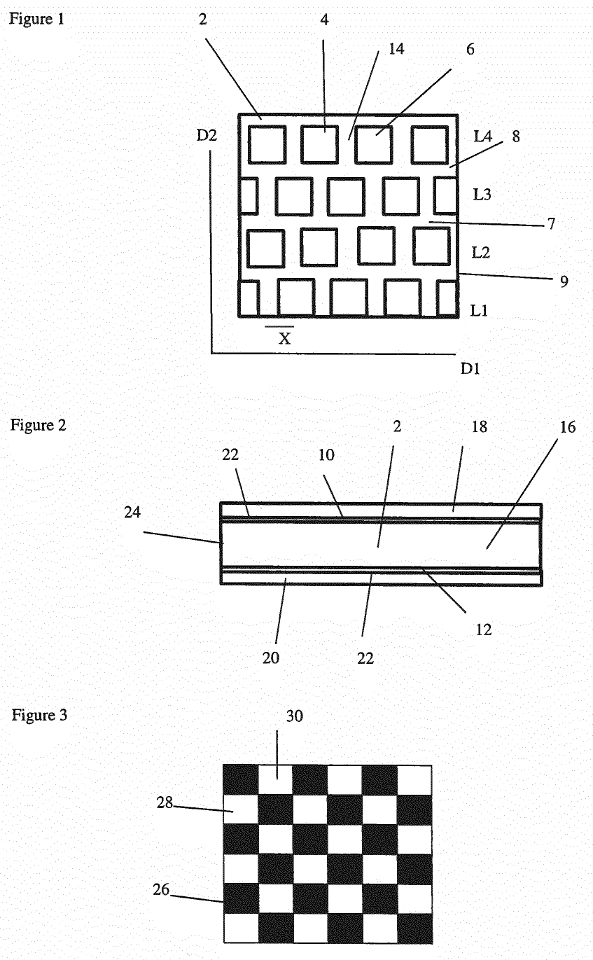

Referring to FIGS. 1 and 2, FIG. 1 shows a core 2 according to an embodiment of the present invention and FIG. 2 shows the core 2 incorporated into a composite material sandwich panel. In these Figures, some dimensions are exaggerated for the purpose of clarity of illustration. As described above, the preferred embodiments of the present invention employ balsa as the wood forming the elements in the core, but the present invention can additionally use any other wood material. Therefore in the following description the balsa used in any embodiment or Example may be partly substituted by any other suitable wood.

The core 2 is for forming a composite material sandwich panel. The core 2 comprises an array 4 of a plurality of aligned elongate balsa elements 6 in a continuous matrix 8 of a polymeric foam. The matrix 8 of polymeric foam has been moulded around the elements 6, the matrix filling voids 7 between adjacent elements 6 and bonding together the elements 6 to form a unitary body 9. The core 2 has respective opposite major surfaces 10, 12. The array 4 of balsa elements 6 extends between the opposite major surfaces 10, 12 in a thickness direction of the core 2. The woodgrain, and the vessels and axial parenchyma cells, of the balsa elements 6 extend in the thickness direction.

The balsa elements 6 have from 15 to 100 mm, optionally the same cross-sectional shape and dimensions, which are from 15 to 100 mm, optionally uniform along the length of the balsa elements 6 extending in the thickness direction. In alternative embodiments, the balsa elements 6 may have different cross-sectional shape and/or dimensions.

The array 4 is a regular array and the matrix 8 of polymeric foam separates each balsa element 6 in the array 4 from adjacent balsa elements 6 in the array 4. Typically, each balsa element 6 in the array 4 is separated from adjacent balsa elements 6 in the array 4 by a thickness of from 3 to 50 mm, optionally from 3 to 25 mm, further optionally from 3 to 15 mm of the polymeric foam, and/or the thickness of the polymeric foam is from 25 to 75% of a maximum width of the respective balsa element 6. The opposite major surfaces 10, 12 each have a surface area which comprises from 40 to 60% balsa and from 60 to 40% polymeric foam, for example from 40 to less than 50% balsa and greater than 50 to up to 60% polymeric foam.

In the illustrated embodiment, the array 4 is a rectangular array having first and second orthogonal directions D1, D2. In the first orthogonal direction D1 the balsa elements 6 in the array 4 form a plurality of parallel lines L1, L2, etc., each comprising a series of the balsa elements 6. In the second orthogonal direction D2 the balsa elements 6 in each parallel line L1, L2, etc., are offset, in the first orthogonal direction D1, relative to the balsa elements 6 in the adjacent parallel lines L1, L2, etc. in the second orthogonal direction D2. Preferably, the balsa elements 6 in each parallel line L1, L2, etc. are offset, in the first orthogonal direction D1, relative to the balsa elements 6 in the adjacent parallel lines L1, L2, etc. by an offset distance X which is from 25 to 85%, for example from 25 to 75%, of the total width of the balsa element 6 and an adjacent layer 14 of polymeric foam on one side of the balsa element 6 in the first orthogonal direction D1. Typically, the offset distance X is from 45 to 55% of the total width of the balsa element 6 and the adjacent layer 14 of polymeric foam on one side of the balsa element 6 in the first orthogonal direction D1.

Typically, in the second orthogonal direction D2 the balsa elements 6 in each parallel line L1, L2, etc. are offset so that for any four adjacent parallel lines L1, L2, L3, L4 etc., the balsa elements 6 in the first and third parallel lines L1, L3, are mutually aligned along the second orthogonal direction D2 and are offset in the first orthogonal direction D1 relative to the balsa elements 6 in the second and fourth parallel lines L2, L4, the balsa elements 6 in the second and fourth parallel lines L2, L4, being mutually aligned along the second orthogonal direction D2. This structure forms a “header-bond” relationship between the balsa elements 6 and layers forming the continuous matrix 8 of polymeric foam.

In the preferred embodiments, the balsa element 6 has a polygonal cross-section, having a plurality of elongate planar sides extending lengthwise along the balsa element 6 in the thickness direction of the core 2. The polygonal cross-section may have any regular polygonal shape, for example triangular, pentagonal, hexagonal, etc., but preferably the polygonal cross-section is rectangular or square.

In the preferred embodiments, the polygonal cross-section has a maximum width dimension of from 15 to 100 mm, optionally from 15 to 50 mm, and preferably a minimum width dimension of from 15 to 100 mm, optionally from 15 to 50 mm. Typically, the polygonal cross-section is rectangular or square with a maximum width dimension of from 15 to 50 mm, optionally from 15 to 30 mm and a minimum width dimension of from 15 to 50 mm, optionally from 15 to 30 mm. For example, the balsa element 6 has a square cross-section with length and width dimensions of 20 mm. Typically, each balsa element 6 in the array 4 has substantially the same cross-sectional shape and dimensions.

In the preferred embodiments, the polymeric foam is a closed cell foam. Preferably, the polymeric foam is a polyurethane foam. Typically, the polymeric foam has a density of from 20 to 150 kg/m³, for example from 20 to 100 kg/m³, typically from 20 to 65 kg/m³. The core 2 comprises a structural arrangement of a relatively high density balsa and a relatively low density polymeric foam, with a volume relationship between the balsa and polymeric foam so that the density of the core 2 is between the density values for the balsa and polymeric foam.

When the opposite major surfaces 10, 12 each have a surface area which comprises from 40 to 60% balsa and from 60 to 40% polymeric foam, for example from 40 to less than 50% balsa and greater than 50 to up to 60% polymeric foam as described above, there is a corresponding volume relationship for the balsa and polymeric foam since the core has straight parallel sides and the elements have straight sides. That volume relationship correspondingly determines the density of the core 2 relative to the density values for the balsa and polymeric foam.

As described above, the balsa is rigid and therefore has a high elastic modulus (E). The polymeric foam is selected to have a lower elastic modulus (E) than the balsa. Accordingly, in the core 2, the structural assembly of the balsa elements 6 in the continuous matrix 8 of polymeric foam provides a lower elastic modulus (E) for the entire core 2 than that of the balsa alone. Moreover, as also described above, the balsa has a high shear strength, and a high shear modulus (G). The polymeric foam has a lower shear modulus (G) than the balsa, but the structural assembly of the balsa elements 6 in the continuous matrix 8 of polymeric foam nevertheless provides a high shear modulus (G) for the entire core 2. Furthermore, preferably the Poisson ratios of the balsa and polymeric foam are substantially the same so that the core is substantially uniformly compressed in the regions of both the balsa and the polymeric foam.

In the preferred embodiments, the polymeric foam has a compressive elastic modulus (E) measured according to ISO 844 B of from 5 to 150 MPa, optionally from 5 to 100 MPa, further optionally from 5 to 35 MPa; a shear modulus (G) measured according to ASTM C273 of from 3 to 60 MPa, optionally from 3 to 40 MPa, further optionally from 3 to 10 MPa; and/or a Poisson ratio of from 0.25 to 0.5.

In the preferred embodiments, the wood, preferably balsa, has a density, measured according to ISO 845 2006 after the wood has been conditioned for 24 hrs to reach a moisture level of 10-14 wt %, based on the total weight of the wood, of from 80 to 230 kg/m³, optionally from 100 to 210 kg/m³, further optionally from 120 to 190 kg/m³; a compressive elastic modulus (E) measured according to ISO 844 B of from 1000 to 6000 MPa; and/or a shear modulus (G) measured to ASTM C273 of from 80 to 250 MPa.

In the preferred embodiments, the ratio between the density of the balsa and the polymeric foam is within the range of from 1.5 to 12: 1; the ratio between the elastic modulus (E) of the balsa and the polymeric foam is within the range of from 6 to 1200: 1; and/or the ratio between the shear modulus (G) of the balsa and the polymeric foam is within the range of from 2 to 85: 1.

Typically, the density of the core 2 is from 60 to 150 kg/m³, optionally from 60 to 120 kg/m³, further optionally from 60 to 100 kg/m³.

The core 2 is preferably is in the form of a block 16 having a height, extending in a length direction of the balsa elements 6, of from 100 to 50 mm. Typically, the block 16 has a length and width, orthogonal to the height and orthogonal to each other, each within the range of from 500 to 3000 mm. The block 16 may have a length and width to provide a cross-sectional area of the block 16 of from 250,000 to 1,500,000 mm².

An alternative structure for the cross-section of the core is illustrated in FIG. 3. This structure forms a “checkerboard” relationship between the balsa elements 26 and layers 28 forming the matrix 30 of polymeric foam, the matrix being discontinuous. The balsa elements 26 and layers 28 are square (but may be rectangular), have the same shape and dimensions and are alternately arranged in both orthogonal directions to provide a checkerboard structure. Each corner of each balsa element 26 diagonally contacts a corner of an adjacent balsa element 26 and correspondingly each corner of each layer 28 diagonally contacts a corner of an adjacent layer 28.

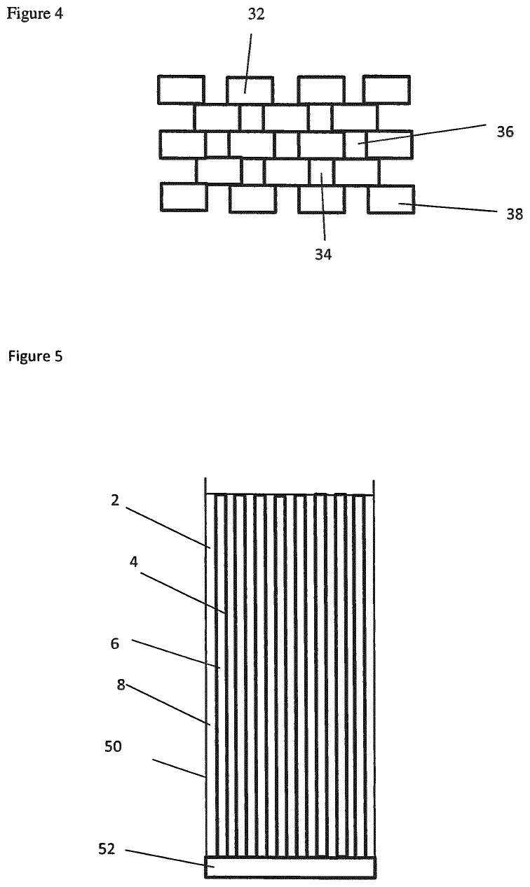

A further alternative structure for the cross-section of the core is illustrated in FIG. 4. This structure forms a “Flemish bond” relationship between the balsa elements 32 and layers 34 forming the matrix 36 of polymeric foam, the matrix being discontinuous. The balsa elements 32 and layers 34 are rectangular and the dimensions of the balsa elements 32 are larger in both length and width than the layers 34. The “Flemish bond” provides that the balsa elements 32 overlap with other balsa elements 32 in adjacent lines at each of the four corners in one orthogonal direction, and balsa elements 32 and layers 34 are alternately arranged in both orthogonal directions to provide a “Flemish bond” structure. The structure has the balsa elements 32 contacting each other to form a continuous body 38 of balsa, built up of the array of plural individual balsa elements, and layers 34 of polymeric foam constituting a regular pattern of isolated regions, or “islands”, of foam within the continuous body 38 of balsa.

The balsa elements 6 are typically made according to the following process. First, a block of solid balsa is provided, which may have a height within the range of 300 to 1500 mm, and typically has a height of 1.2 metres, and a length and width within the range of 0.6 to 1.2 metres, with typically a length of 1200 mm ad a width of 600 mm. The balsa elements, typically 20 mm×20 mm square and having the same height, are cut from this block.

As shown in FIG. 5, in a method of manufacturing the core 2, the array 4 of aligned elongate balsa elements 6 is provided elements in a mould 50. The elements may have the dimensions as described in the preceding paragraph. The array 4 is temporarily held in position by a jig 52. Then a matrix of a polymeric foam is formed around the array 4 within the mould 50 to form a moulded core 2. The matrix 8 is formed either by pumping pre-foamed polyurethane into the mould 50 or by pumping a foamable polyurethane, comprising the polyurethane resin and a foaming or blowing agent, as known in the art, into the mould 50 so that the polymeric foam expands and forms in situ within the mould 50. In either case, the polymeric foam bonds directly to the edge surfaces of the elongate balsa elements 6. After formation of the core 2, the height, length and width of the core may be cut to any desired dimension. Alternatively, the core may be moulded to form a preset height, length and width of the core. Typically, the moulding method forms a unitary moulded block of wood elements and foam matrix having a height of 300 to 1500 mm (the height being measured in the longitudinal direction of the elongate elements 6 of FIG. 5), a length of 600 to 1200 mm and a width of 600 to 1200 mm, and then the block is cut in a direction orthogonal to the height to form a plurality of individual cores each having a height of from 10 to 50 mm.

As shown in FIG. 2, the present invention further provides a composite material sandwich panel 24 in which the core 2 is sandwiched between opposed outer layers 18, 20 of fibre reinforced matrix resin material, as shown in FIG. 2. The outer layers 18, 20 of fibre reinforced matrix resin material preferably comprise at least one of glass fibres and carbon fibres and a cured thermoset, e.g. epoxy, resin matrix. Other resins could be employed, such as vinyl ester resins, which are known for use in manufacturing sandwich panels. The cured thermoset resin is bonded to the opposite major surfaces 10, 12 of the core by a coating layer 22 comprising a cured bonding resin.

The cured bonding resin is initially applied to the opposite major surfaces 10, 12 as a curable resin composition, for example comprising at least one polymerisable unsaturated monomer, preferably at least one acrylate or methacrylate monomer and, as an elastomer, at least one urethane acrylate monomer, and a curing agent for polymerising the at least one polymerisable monomer. However, other curable resin compositions may be employed. The curable resin composition preferably includes an elastomer component so that the cured resin layer has flexibility and does not tend to crack or de-adhere from the core or the laminate resin when the resultant sandwich panel is subjected to bending stresses.

The curing may be carried out by thermal radiation heat, ultraviolet radiation or electron beam radiation, or any other suitable electromagnetic radiation which can rapidly cure the resin composition. Preferably, ultraviolet radiation is used, in which case the curing agent comprises a photoinitiator initiated by ultraviolet radiation. The curing is therefore rapidly effected after coating of the resin, to minimise the time period during which the uncured resin can flow into the balsa vessels, and rapidly substantially fully cures the entire resin coating, so as to ensure that there is substantially no further resin penetration after the rapid cure.

The invention provides an engineered balsa core in which a high proportion of the surface area of the core surface which is bonded to the opposed structural plies is provided by the polymeric foam rather than the end surfaces of the balsa elements. Consequently, resin penetration into the balsa is controlled and minimised, thereby minimising resin take-up into the balsawood.

The composite material sandwich panel can be incorporated into a structural element such as a wind turbine blade, or a marine component or craft.

The present invention is further illustrated with reference to the following non-limiting Examples.

### EXAMPLE 1

A balsa core having a cross-section as illustrated in FIG. 1 was provided. The balsa elements had a square cross-section of 20 mm×20 mm. The balsa elements were separated by a foam layer of 10 mm forming a continuous foam matrix. The foam comprised a polyurethane foam having a density of 62 kg/m³. The foam had an elastic modulus (E) of 17 MPa, a shear modulus (G) of 6.3 MPa and a Poisson ratio of 0.35.

When used to manufacture a wind turbine blade having a main blade portion formed of a 40 mm thickness of the core covered by two opposed outer skins of a single ply of 1200 gsm glass fibre epoxy resin composite, the buckling performance under an applied axial load was determined by finite element analysis (FEA) and quantified as a relative buckling performance (RBP) of 1.

In contrast, a commercial PVC structural foam having a density of 60 kg/m³, which is sold by the Applicant under the trade name “PVC 60” also has a relative buckling performance (RBP) of 1 but has a higher production cost than the hybrid engineered balsa core of Example 1. Although the hybrid engineered balsa core of Example 1 would exhibit some increased weight as compared to PVC 60, the hybrid engineered balsa core of Example 1 allows substantially similar structural properties to be achieved at lower cost.

Further in contrast, the hybrid engineered balsa core of Example 1 would exhibit decreased weight and decreased cost as compared to a conventional balsa-only core.

### EXAMPLE 2

A balsa core having a cross-section as illustrated in FIG. 3 was provided. The balsa elements had a square cross-section of 20 mm×20 mm. The balsa elements were separated by a foam layer having square regions of 20×20 mm forming a discontinuous foam matrix. The foam comprised a polyurethane foam having a density of 62 kg/m³. The foam had an elastic modulus (E) of 17 MPa, a shear modulus (G) of 6.3 MPa and a Poisson ratio of 0.35.

When used to manufacture a wind turbine blade having a main blade portion formed of a 40 mm thickness of the core covered by two opposed outer skins of a single ply of 1200 gsm glass fibre epoxy resin composite, the buckling performance under an applied axial load was determined by finite element analysis (FEA) and quantified as a relative buckling performance (RBP) of 1.2. This example provided a similar axial buckling performance as Example 1, but the checkerboard structure of Example 2 has a reduced foam proportion than the header bond structure of Example 1 and so exhibits higher weight and cost as compared to Example 1.

### EXAMPLE 3

A balsa core having a cross-section as illustrated in FIG. 4 was provided. The balsa elements had a rectangular cross-section of 30 mm wide×60 mm long and the foam regions were rectangular with a cross-section of 30 wide×40 mm long forming a discontinuous foam matrix. The foam comprised a polyurethane foam having a density of 62 kg/m³. The foam had an elastic modulus (E) of 17 MPa, a shear modulus (G) of 6.3 MPa and a Poisson ratio of 0.35.

When used to manufacture a wind turbine blade having a blade root formed of a 25 mm thickness of the core covered by two opposed outer skins of three plies of 1200 gsm glass fibre epoxy resin composite, the buckling performance under an applied transverse load was determined by finite element analysis (FEA) and quantified as a relative buckling performance (RBP) of 3.0.

In contrast, a commercial PVC structural foam having a density of 60 kg/m³, which is sold by the Applicant under the trade name “PVC 60” had a relative buckling performance (RBP) of only 1.0. This Example can provide higher structural properties than PVC 60 foam at lower cost and weight than 100% of a typical balsa used for core manufacture.

1. A core for a composite material sandwich panel, the core comprising a regular array of a plurality of aligned elongate elements, composed of balsa wood, in a continuous matrix of a polymeric foam which has been moulded around the elements, wherein the elements each have a polygonal cross-section, the matrix filling voids between adjacent elements and bonding together the elements to form a unitary body, wherein the array is a rectangular array having first and second orthogonal directions, in the first orthogonal direction the elements in the array forming a plurality of parallel lines, each parallel line comprising a series of the elements, and the elements in each parallel line being offset, in the first orthogonal direction, relative to the elements in the parallel lines which are adjacent in the second orthogonal direction, wherein the core has respective opposite major surfaces, the array of elements extends between the opposite major surfaces in a thickness direction of the core and wherein woodgrain of the elements extends in the thickness direction.

2. A core according claim 1 wherein the elements have substantially the same cross-sectional shape and dimensions.

3. A core according to claim 2 wherein the cross-sectional shape and dimensions of the elements are substantially uniform along the length of the elements.

4. A core according to claim 1 wherein the matrix of polymeric foam separates each element in the array from adjacent elements in the array.

5. A core according to claim 4 wherein each element in the array is separated from adjacent elements in the array by a thickness of from 3 to 50 mm, or from 3 to 25 mm, or from 3 to 15 mm of the polymeric foam.

6. A core according to claim 4 wherein each element in the array is separated from adjacent elements in the array by a thickness of the polymeric foam which is from 25 to 75% of a maximum width of the respective elements.

7. A core according to claim 1 wherein the opposite major surface each have a surface area which comprises from 40 to 60% wood and from 60 to 40% polymeric foam.

8. A core according to claim 7 wherein the opposite major surfaces each have a surface area which comprises from 40 to less than 50% wood and greater than 50 to up to 60% polymeric foam.

9. A core according to claim 1 wherein the elements in each parallel line are offset, in the first orthogonal direction, relative to the elements in the adjacent parallel lines by an offset distance which is from 25 to 85% of the width of the elements in the first orthogonal direction.

10. A core according to claim 9 wherein the offset distance is from 25 to 75%, or from 45 to 55%, of the total width of the element and an adjacent layer of polymeric foam on one side of the element in the first orthogonal direction.

11. (canceled)

12. A core according to claim 1 wherein in the second orthogonal direction the elements in each parallel line are offset so that for any four adjacent parallel lines, the elements in the first and third parallel lines are mutually aligned along the second orthogonal direction and are offset in the first orthogonal direction relative to the elements in the second and fourth parallel lines, the elements in the second and fourth parallel lines being mutually aligned along the second orthogonal direction.

13. A core according to claim 1 wherein the polygonal cross-section is rectangular or square.

14. A core according to claim 1 wherein the polygonal cross-section has a maximum width dimension of from 15 to 100 mm, or from 15 to 50 mm.

15. A core according to claim 14 wherein the polygonal cross-section has a minimum width dimension of from 15 to 100 mm, or from 15 to 50 mm.

16. A core according to claim 15 wherein the polygonal cross-section is rectangular or square with a maximum width dimension of from 15 to 50 mm, or from 15 to 30 mm, and a minimum width dimension of from 15 to 50 mm, or from 15 to 30 mm.

17. A core according to claim 1 wherein each element in the array has substantially the same cross-sectional shape and dimensions.

18. A core according to claim 1 wherein the polymeric foam is a closed cell foam and/or a polyurethane foam.

19. (canceled)

20. A core according to claim 1 wherein the polymeric foam has one or any combination of the following: the polymeric foam has a density of from 20 to 150 kg/m³, or from 20 to 100 kg/m³, or from 20 to 65 kg/m³; the polymeric foam has a compressive elastic modulus (E) measured according to ISO 844 B of from 5 to 150 MPa, or from 5 to 100 MPa, or from 5 to 35 MPa; the polymeric foam has a shear modulus (G) measured according to ASTM C273 of from 3 to 60 MPa, or from 3 to 40 MPa, or from 3 to 10 MPa; and
the polymeric foam has a Poisson ratio of from 0.25 to 0.5.

21. (canceled)

22. (canceled)

23. (canceled)

24. A core according to claim 1 wherein the balsa wood has a density, measured according to ISO 845 2006 after the wood has been conditioned for 24 hrs to reach a moisture level of 10-14 wt %, based on the total weight of the wood, of from 80 to 230 kg/m³, or from 100 to 210 kg/m³, or from 120 to 190 kg/m³; the balsa wood has a compressive elastic modulus (E) measured according to ISO 844 B of from 1000 to 6000 MPa; and the balsa wood has a shear modulus (G) measured to ASTM C273 of from 80 to 250 MPa.

25. (canceled)

26. (canceled)

27. A core according to claim 1 wherein the balsa wood and the polymeric foam have one or any combination of the following: the ratio between the density of the balsa wood and the polymeric foam is within the range of from 1.5 to 12:1; the ratio between the elastic modulus (E) of the balsa wood and the polymeric foam is within the range of from 6 to 1200:1; and the ratio between the shear modulus (G) of the balsa wood and the polymeric foam is within the range of from 2 to 85:1.

28. (canceled)

29. (canceled)

30. A core according to claim 1 wherein the density of the core is from 60 to 160 kg/m³, or from 60 to 120 kg/m³, or from 60 to 100 kg/m³.

31. A core according to claim 1 which is in the form of a block having a height, extending in a length direction of the elements, of from 10 to 50 mm; wherein the block has a length and width each within the range of from 500 to 3000 mm and wherein the block has a length and width to provide a cross-sectional area of the block of from 250,000 to 1,500,000 mm².

32. (canceled)

33. (canceled)

34. A method of manufacturing a core for a composite material sandwich panel according to claim 1, the method comprising the steps of:
(a) providing an array of a plurality of aligned elongate elements, composed of balsa wood, in a mould; and
(b) forming a matrix of a polymeric foam around the array within the mould to form a moulded core, the matrix filling voids between adjacent elements and bonding together the elements to form a unitary body.

35. A composite material sandwich panel comprising a core according to claim 1 sandwiched between opposed outer layers of fibre reinforced matrix resin material.

36. A composite material sandwich panel according to claim 35 wherein the outer layers of fibre reinforced matrix resin material comprise at least one of glass fibres and carbon fibres and a cured thermoset resin matrix, the cured thermoset resin being bonded to opposite major surfaces of the core.

37. A structural element incorporating the composite material sandwich panel of claim 35.

38. A wind turbine blade, or a marine component or craft, incorporating a structural element according to claim 37.
